(19) United States
(12) Patent Application Publication
(10) Pub. No.: US 2026/0320486 A1
(43) Pub. Date: Oct. 15, 2026

(54) COMPUTER-IMPLEMENTED SYSTEM AND METHOD FOR DATA-ENABLED REGULATORY FORESIGHT, AUTOMATED POLICY DEVELOPMENT, DECENTRALIZED GOVERNANCE, AND SANDBOX-BASED REGULATORY TESTING

(71) Applicant: Ugochukwu Chigoziem Ikpeazu, Fintas Al Ahmadi (KW)

(72) Inventor: Ugochukwu Chigoziem Ikpeazu, Fintas Al Ahmadi (KW)

(21) Appl. No.: 19/466,317

(22) Filed: Jan. 31, 2026

(30) Foreign Application Priority Data
Feb. 12, 2025 (NG) NG/P/2025/29

(51) Int. Cl. G06N 20/00; G06F 18/21; G06Q 10/04

(52) U.S. Cl. CPC G06N 20/00; G06F 18/217; G06Q 10/04

(57) ABSTRACT

A computer-implemented system and method for predictive regulatory foresight, policy development, and sandbox-based regulatory testing are disclosed. The system integrates data ingestion, machine-learning-based predictive analytics, artificial intelligence-driven policy generation, decentralized governance mechanisms, and simulation environments to design, evaluate, and refine regulatory frameworks prior to adoption. The invention enables proactive, transparent, and evidence-based regulation for emerging technologies.

### CROSS REFERENCE TO RELATED APPLICATION

“This application claims priority to Nigerian Patent Application No. NG/P/2025/29, filed Feb. 12, 2025.”

### FEDERALLY SPONSORED RESEARCH AND DEVELOPMENT

“Not Applicable”

### JOINT RESEARCH AGREEMENT

“Not Applicable”

### INCORPORATION-BY-REFERENCE OF MATERIAL SUBMITTED

“Not Applicable”

### STATEMENT REGARDING PRIOR DISCLOSURE BY THE INVENTOR

“Not Applicable”

### FIELD OF THE INVENTION

The present invention relates to regulatory technology (RegTech), artificial intelligence, and computer-implemented governance systems. More particularly, the invention relates to systems and methods for predictive regulatory foresight, automated policy generation, decentralized governance, and sandbox-based simulation of regulatory impact prior to real-world adoption or enforcement.

### BACKGROUND OF THE INVENTION

Regulatory frameworks governing emerging technologies are traditionally reactive, fragmented, and jurisdictionally inconsistent. Regulatory authorities often respond only after technological adoption has occurred, resulting in regulatory lag, compliance uncertainty, market inefficiencies, and unintended societal consequences.

Existing regulatory technology solutions primarily focus on post-implementation compliance, enforcement monitoring, or document analysis. Such systems assume the prior existence of regulations and are limited to interpreting, validating, or enforcing those regulations. While artificial intelligence, natural language processing, and blockchain technologies have individually been applied to compliance automation or governance transparency, these tools do not provide a cohesive technical solution for anticipating regulatory needs, designing regulatory frameworks, governing their creation, and empirically testing their impact prior to adoption.

Furthermore, current policy-making processes lack predictive modeling, structured stakeholder governance, and simulation-based validation. Regulatory decisions are often made without the benefit of data-driven foresight or controlled testing environments, leading to inefficient or ineffective regulatory outcomes.

Accordingly, there exists a need for a computer-implemented system that enables proactive, data-driven regulatory foresight, collaborative policy generation, decentralized governance, and sandbox-based regulatory testing. The present invention addresses these deficiencies.

The rapid development of emerging technologies such as artificial intelligence (AI), blockchain, and the Internet of Things (IoT) is transforming industries, society, and the legal landscape. These advancements pose significant challenges to traditional legal frameworks, particularly in areas of privacy, intellectual property, and liability. This paper argues for the necessity of adaptive legal frameworks that incorporate predictive modelling to address these challenges effectively. By analyzing the limitations of existing legal structures in keeping pace with technological evolution, the paper underscores the importance of proactive, dynamic regulatory approaches. Modelling methodologies such as legal informatics, scenario modelling, and computational law can provide lawmakers with tools to anticipate legal issues arising from new technologies. Case studies highlight the practical impacts of technologies like AI in contract review, blockchain in secure transactions, and smart contracts in automated legal agreements, illustrating the urgent need for responsive regulation. The paper concludes by recommending a forward-looking framework that leverages predictive modelling to guide the creation of flexible regulations, ensuring legal systems can adapt to future technological advancements. It further emphasizes the importance of interdisciplinary collaboration among professionals, technologists, and ethicists to ensure regulations balance innovation with public interest protection. Although artificial intelligence and digitalization have brought a radical transformation in the field of legal practice, facilitating the optimization of processes and improving the efficiency and accessibility of legal services, important legal gaps persist, which require developing and implementing clear and robust mechanisms that ensure the veracity and reliability of the information managed and distributed through these emerging technologies. Legislation in many jurisdictions around the world, frequently fails to keep up with the accelerated pace of innovations. This mismatch between technological advancement and regulatory updating presents numerous challenges and risks, especially in the context of legal practice.

Technological innovation across domains such as artificial intelligence, blockchain, financial technology, biotechnology, and digital platforms is advancing at a pace that significantly exceeds the capacity of traditional regulatory frameworks to adapt. Existing regulatory systems are predominantly reactive in nature, relying on post-deployment compliance monitoring, enforcement actions, or retrospective policy revisions after harm, market disruption, or legal uncertainty has already occurred.

This reactive regulatory model creates regulatory lag, fragmented oversight, inconsistent enforcement, and uncertainty for innovators, regulators, and affected stakeholders. In many jurisdictions, regulatory authorities lack the technical tools required to anticipate how emerging technologies will interact with existing legal frameworks, economic systems, and societal norms before such technologies are deployed at scale.

While certain RegTech solutions exist, these systems are largely limited to compliance automation, reporting, and monitoring of existing rules. Such systems do not provide predictive insight into future regulatory risks, nor do they enable regulators to test or simulate the effects of proposed regulations prior to adoption. Similarly, existing policy development processes are typically manual, slow, and siloed, relying heavily on human drafting, consultation, and political negotiation without systematic data-driven foresight.

Additionally, conventional regulatory governance structures are centralized and opaque, limiting meaningful participation by technical experts, industry stakeholders, and the public. This often results in regulations that are misaligned with technological realities, economically inefficient, or vulnerable to rapid obsolescence.

Accordingly, there exists a need for a computer-implemented regulatory system that enables proactive, data-driven regulatory foresight; automated and intelligent policy development; decentralized and transparent governance; and sandbox-based testing of regulatory proposals prior to real-world implementation. The present invention addresses these deficiencies

### PRIOR ART LIST

US20250252450A1—AI-Blockchain Regulatory and Compliance Engine:

Automates regulatory compliance via blockchain and NLP; does not disclose predictive foresight, DAO governance, or generation of new regulatory drafts.

US12105729B1—Generative AI Governed Search and Document Generation System: Generates compliance-related documents from regulatory data but lacks predictive modeling and decentralized governance.

US12111754B1—AI-Based Compliance Validation and Testing System: Provides automated compliance testing and validation; does not generate or forecast regulatory frameworks.

WO2024209407A1—AI Governance and Risk Management Platform: Supports governance reporting and AI risk dashboards without automated regulation drafting or sandbox testing.

US10984483B2—Cognitive Regulatory Compliance Automation of Blockchain: Extracts regulatory obligations and enforces compliance via smart contracts; does not create new regulations.

US20250086556A1—AI-Powered Governance and Business Management Platform: General governance framework not directed to regulatory foresight or sandboxed regulation testing.

US20240273411A1—AI Regulatory Enforcement and Safeguard Mechanisms: Focuses on enforcement controls rather than proactive regulatory development.

WO2019100084A1—Decentralized Autonomous Evaluation Engine: Uses decentralized predictive evaluation but outside regulatory drafting and governance context.

US8095496B2—Multi-Agent System Architecture: General multi-agent coordination architecture; non-regulatory application.

US10896214B2—AI-Based Document Processing and Visualization: Processes complex documents without predictive or governance components.

US20170287038A1—Autonomous Negotiation Agent System: AI agent negotiation mechanisms unrelated to regulatory drafting.

US11983488B1—Large Language Model Text Generation System: General-purpose text generation without regulatory foresight or consensus governance.

US20240256582A1—AI Generative Platform: Generic generative AI system lacking regulatory-specific application.

US20240289802A1—Blockchain-Based AI Risk Detection System: Predicts operational risks and alerts authorities but does not draft or test regulations.

WO2020168299A1—BLOCKCHAIN-BASED AI ACCOUNTABILITY AND GOVERNANCE System.

### SUMMARY OF THE INVENTION

The present invention provides a computer-implemented regulatory foresight and policy development platform that enables proactive, data-driven design, governance, and testing of regulatory frameworks prior to real-world adoption or enforcement.

In one embodiment, the invention operates by ingesting large volumes of heterogeneous data, including regulatory texts, legislative materials, technological disclosures, market indicators, innovation trends, and societal datasets. This data is normalized and semantically structured to enable machine-learning analysis. A predictive analytics engine processes the structured data to identify regulatory gaps, emerging risks, and anticipated future regulatory requirements.

Based on predictive outputs, an artificial intelligence-driven policy generation engine automatically produces structured draft regulatory frameworks, policy rules, or governance guidelines. These drafts include traceable rationale metadata linking regulatory provisions to underlying data sources and predictive signals.

The invention further incorporates a decentralized governance layer that enables transparent, auditable, and multi-stakeholder participation in regulatory development. Stakeholders may review outputs, set guidance rules for the system, propose modifications to outputs, and approve regulatory drafts using consensus mechanisms, including decentralized autonomous organization (DAO) protocols recorded on a distributed ledger.

Critically, the invention includes a sandbox simulation environment that evaluates proposed regulatory frameworks prior to adoption. The sandbox models economic impact, compliance burden, technological feasibility, enforcement dynamics, and societal outcomes. Simulation results are fed back into the predictive analytics and policy generation engines, enabling iterative refinement. Through this closed-loop architecture, the invention transforms regulatory development into a dynamic, adaptive, and computationally optimized process, reducing regulatory lag and unintended consequences while improving regulatory effectiveness.

### BRIEF DESCRIPTION OF THE DRAWINGS

FIG. 1 is an overall system architecture & deployment embodiment;

FIG. 2 is a Layered regulatory technology stack;

FIG. 3 is a decentralized governance framework;

FIG. 4 is an AI-driven policy drafting workflow;

FIG. 5 is a regulatory sandbox simulation and feedback loop.

### DETAILED DESCRIPTION OF FIGURES.

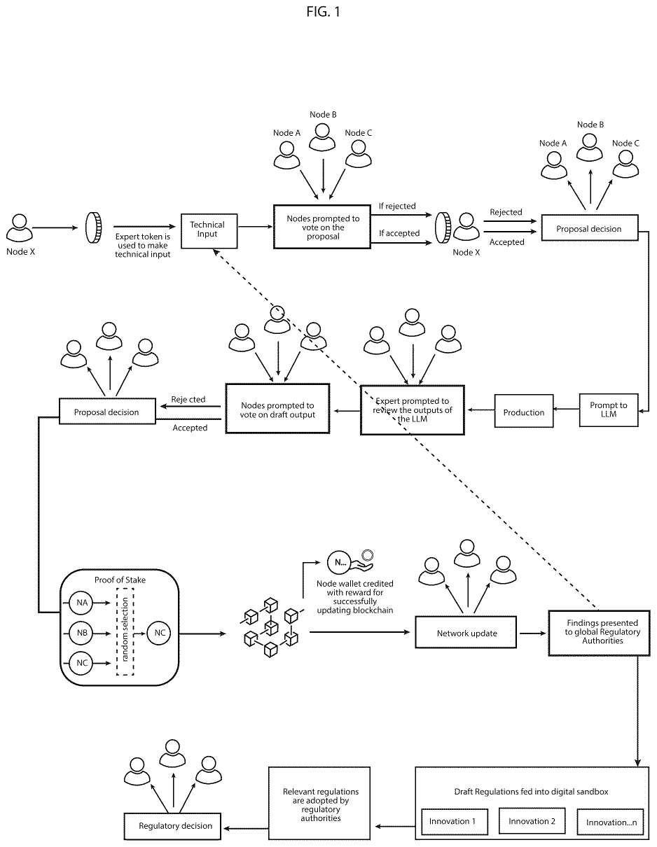

FIG. 1 illustrates an overall system architecture of a computer-implemented regulatory foresight platform according to the present invention. The system comprises one or more processors, memory devices, and interconnected functional modules configured to perform data ingestion, predictive analytics, policy generation, governance validation, and regulatory sandbox simulation.

In some embodiments, the system architecture illustrated in FIG. 1 is implemented as a centralized computing platform executing on one or more servers. In other embodiments, the system is implemented as a distributed or federated architecture spanning multiple computing nodes, including cross-jurisdictional or multi-agency deployments.

In some embodiments, system components communicate through secure application programming interfaces (APIs). In other embodiments, communication occurs through message queues, event-driven architectures, or distributed ledger-based communication protocols.

Deployment configurations, including cloud-based, on-premises, or hybrid environments, are embodiments of the system illustrated in FIG. 1 and are not shown as separate figures.

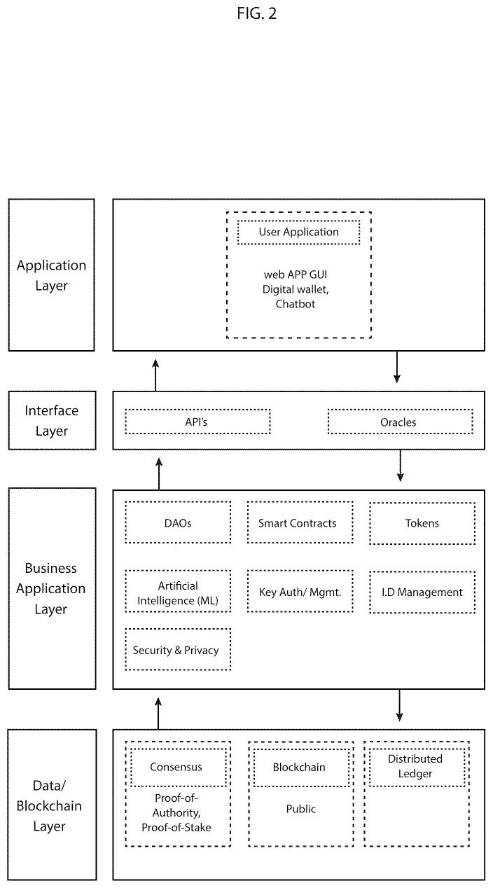

FIG. 2 illustrates a layered regulatory technology stack of the system shown in FIG. 1. The stack comprises a data ingestion layer, a predictive analytics layer, a policy generation layer, a governance layer, and a regulatory sandbox simulation layer.

In some embodiments, the layers operate sequentially such that outputs from one layer are provided as inputs to a subsequent layer. In other embodiments, two or more layers operate asynchronously, in parallel, or in partially overlapping manners depending on regulatory context or system configuration.

In some embodiments, individual layers may be dynamically enabled, disabled, or substituted without affecting the operability of the overall system.

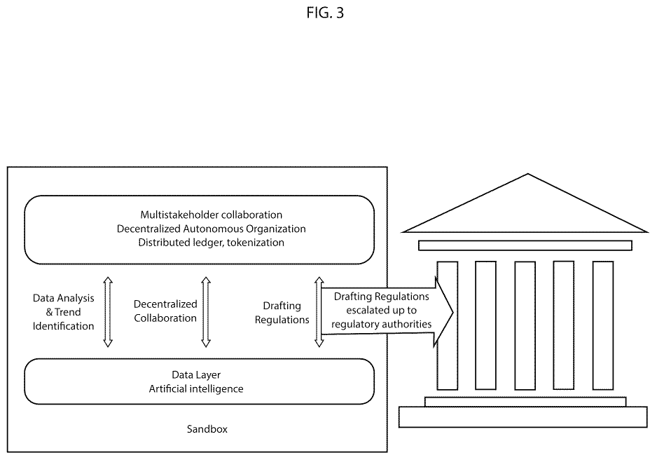

FIG. 3 illustrates a decentralized governance framework for validating proposed regulatory outputs generated by the system.

In some embodiments, the governance framework is implemented using a distributed ledger or blockchain-based consensus mechanism that enables transparent voting, auditability, and immutable recordkeeping. In other embodiments, the governance framework is implemented using a permissioned consortium network, role-based access control, or a hybrid centralized-decentralized governance structure.

In some embodiments, governance participants include regulators, subject-matter experts, industry stakeholders, or representatives of affected communities. In some embodiments, participants are incentivized using reputation scores, weighted voting privileges, access rights, or tokenized incentives.

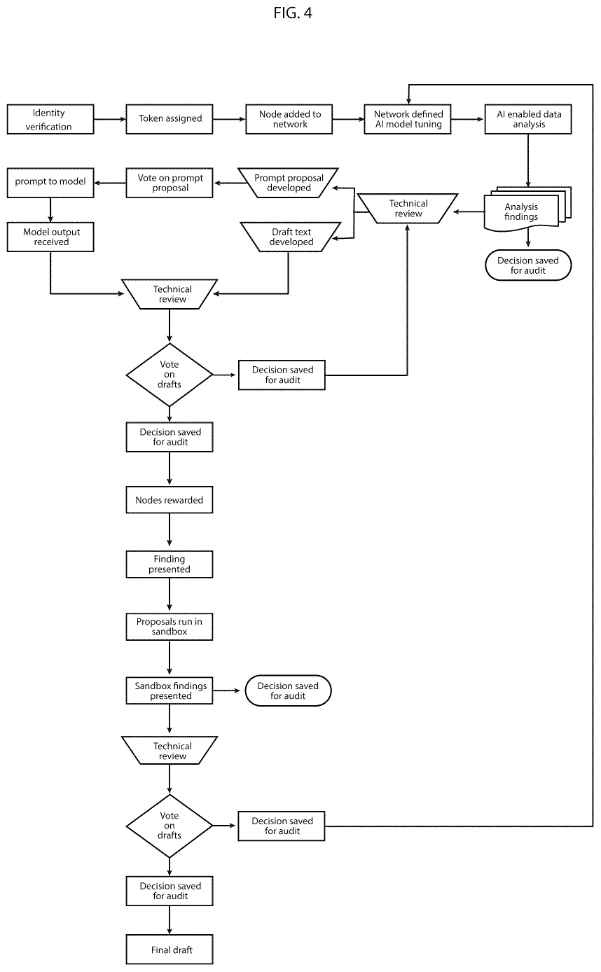

FIG. 4 illustrates an artificial intelligence-driven policy drafting workflow of the system.

In some embodiments, an AI-based policy generation engine automatically produces draft regulatory text using natural language processing models trained on historical legislation, administrative rules, enforcement actions, and policy outcomes. In other embodiments, the policy generation engine produces structured regulatory outputs including clauses, thresholds, compliance parameters, enforcement rules, or risk matrices rather than full textual drafts.

In some embodiments, generated regulatory outputs are reviewed, edited, annotated, or approved by human experts through the governance framework illustrated in FIG. 3. In other embodiments, regulatory outputs are automatically approved upon satisfaction of predefined confidence thresholds or governance rules.

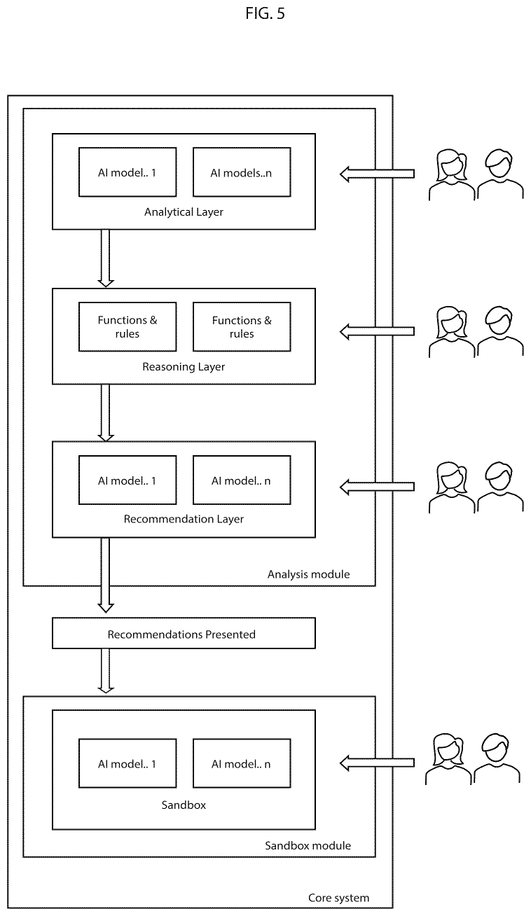

FIG. 5 illustrates a regulatory sandbox simulation environment configured to test proposed regulatory outputs prior to adoption. In some embodiments, the sandbox simulation environment utilizes synthetic datasets or historical data to emulate real-world deployment conditions. In other embodiments, the sandbox integrates live or near-real-time operational data to evaluate regulatory performance under dynamic conditions.

In some embodiments, sandbox simulations include stress-testing regulatory outputs against hypothetical scenarios, edge cases, or projected market behaviors. In some embodiments, simulation results are scored using predefined risk, compliance, economic, or social impact metrics.

In some embodiments, results from the regulatory sandbox simulation are iteratively fed back into one or more of the predictive analytics layers or the policy generation layer illustrated in FIG. 2, thereby forming a closed-loop regulatory development cycle in which proposed regulations are refined prior to enactment.

1. A computer-implemented regulatory foresight system, comprising:
I. ingesting regulatory, technological, market, and stakeholder data;
II. analyzing the ingested data using a predictive analytics engine to forecast potential regulatory impacts of emerging technologies;
III. generating proposed regulatory outputs using an artificial intelligence-based policy generation engine;
IV. subjecting the proposed regulatory outputs to a governance validation process; and
V. simulating implementation of the proposed regulatory outputs within a regulatory sandbox environment prior to adoption, wherein simulation results are used to refine the proposed regulatory outputs before enactment.

2. The system of claim 1, wherein the data ingestion module aggregates structured and unstructured data from regulatory databases, technical publications, market data sources, and stakeholder inputs.

3. The system of claim 1, wherein the predictive analytics module is configured to forecast regulatory compliance burdens, economic impact, or societal outcomes resulting from proposed regulatory frameworks.

4. The system of claim 1, wherein the automated policy generation module generates regulatory rules, guidelines, or compliance requirements expressed in both machine-readable and human-readable formats.

5. The system of claim 4, wherein the automated policy generation module employs natural language processing or natural language generation techniques.

6. The system of claim 1, further comprising a decentralized governance module configured to facilitate stakeholder review, validation, and approval of the generated regulatory frameworks.

7. The system of claim 6, wherein the decentralized governance module is implemented using distributed ledger technology to immutably record governance actions and validation outcomes.

8. The system of claim 1, wherein the sandbox simulation module models legal, economic, technical, or societal impacts of the generated regulatory frameworks prior to enforcement.

9. The system of claim 8, wherein the sandbox simulation module executes controlled experimental deployments of regulatory rules within simulated or restricted operational environments.

10. The system of claim 1, wherein simulation outputs are used to retrain or update the machine-learning models of the predictive analytics module.

11. The system of claim 1, further comprising a human-in-the-loop validation interface enabling expert users to review, modify, or approve generated regulatory frameworks.

12. The system of claim 11, wherein expert feedback is incorporated into subsequent cycles of predictive analytics and policy generation.

13. The system of claim 1, wherein the system operates continuously to provide real-time or near-real-time regulatory foresight.

14. The system of claim 1, wherein the generated regulatory frameworks are customized for specific jurisdictions, industries, or technological domains.

15. The system of claim 1, wherein the system generates audit trails documenting regulatory design decisions, simulation parameters, and simulation outcomes.

16. The system of claim 1, wherein the system is implemented as a cloud-based platform accessible via networked client devices.

17. A computer-implemented method for regulatory foresight and policy development, comprising:
executing the data ingestion module, predictive analytics module, automated policy generation module, and sandbox simulation module of the system of claim 1.

18. The method of claim 17, further comprising iteratively updating regulatory frameworks based on feedback generated by sandbox simulation results.

19. A non-transitory computer-readable medium storing instructions that, when executed by one or more processors, cause performance of the method of claim 17.

20. The non-transitory computer-readable medium of claim 19, wherein the instructions further cause decentralized governance validation of generated regulatory frameworks prior to adoption.
